(19) United States
(12) Patent Application Publication
(10) Pub. No.: US 2017/0075422 A1
(43) Pub. Date: Mar. 16, 2017

(54) Wearable Devices and Associated Control of Media Devices

(71) Applicants: Yanbing SUN, Shanghai (CN); Jian WANG, Shanghai (CN); Mark MACDONALD, Beaverton, OR (US); Yoshifumi NISHI, Ushiku (JP); Intel Corporation, Santa Clara, CA (US)

(72) Inventors: Yanbing Sun, Shanghai (CN); Jian Wang, Shanghai (CN); Mark MacDonald, Beaverton, OR (US); Yoshifumi Nishi, Beaverton, OR (US)

(73) Assignee: Intel Corporation, Santa Clara, CA (US)

(21) Appl. No.: 15/125,296

(22) PCT Filed: Jun. 9, 2014
(86) PCT No.: PCT/CN14/79469

§ 371 Date: Sep. 12, 2016

(51) Int. Cl. G06F 3/01; H04R 1/10; G06F 3/16

(52) U.S. Cl. CPC G06F 3/015; G06F 3/165; H04R 1/1016; H04R 1/1041

(57) ABSTRACT

A wearable device (e.g., a headset (100)) for the human ear (202) and having an infrared (IR) temperature sensor (102) to facilitate control of a media device (700) coupled to the wearable device. The control may be based at least in part on the measured temperature indicated by the IR sensor (102) detecting the wearable device as on (or off) an ear of a user.

### TECHNICAL FIELD

The present techniques relate generally to wearable devices and control of media devices, and more particularly, but not exclusively, to headsets having ear-skin temperature sensing to facilitate control of a media device or player.

### BACKGROUND

In general, headsets or headphones may be head-mounted speakers, i.e., a pair of small speakers designed to be held in place close to a user's ears. The headset or headphone may be known as earspeakers, earphones, or, colloquially, cans. In particular, headsets or headphones may be a pair of earspeakers or earphones including those joined by a band placed over the head, for listening to audio signals such as music or speech. Also, headsets or headphones may include in-ear versions known as earbuds or earphones, and which may be relatively small headphones worn inside the ear. In the context of telecommunication, a headset may be a combination of headphone and a microphone. On the other hand, a headset may not have a microphone.

Headsets or headphones may have wires for connection to a media device to receive a media (typically audio) signal from the media device. On the other hand, headsets or headphones may instead have a wireless receiver for a wireless connection to such media devices. The media device as a signal source may be a radio or a media playback device (media player) such as CD player, portable media player, smartphones, tablets, and the like. The media devices including those of mobile platforms may have media playback software such as Microsoft Windows Media Player, RealPlayer, Apple QuickTime Player, smartphone/tablet software and applications, and other software.

Headset solutions for remote control of media devices (players)including mobile media devices typically involve physical buttons. Such buttons may include actions for volume increase, volume decrease, and play/pause, for example. Unfortunately, if the headset is removed from the ears, the media device or player does not pause and will continue to play the audio, unless a physical button is depressed or activated by the user.

Therefore, certain headsets or headphones may include a capacitive motion sensor to measure the capacitive field or coupling (or capacitance) for ear skin contact, and thus detect when the headset is removed from the ears. In response, the headset may stop or pause the playback of the media device or player. However, such a headset configuration with capacitive sensors typically has a relatively high misoperation ratio for at least the reason the capacitive sensors detect the target capacitive field for contact human skin generally, not only contact with the skin of the ear. Thus, even with the headset removed from the ears but contacting a hand or other portion of the human body may confuse the headset control of the media device, resulting for example in continued play of the media player with the headset speaker not in or on the ears.

### BRIEF DESCRIPTION OF DRAWINGS

FIG. 1 is diagrammatical representation of a portion of an exemplary wearable device such as a headset and having an IR sensor to measure temperature in accordance with embodiments of the present techniques.

FIGS. 2-5 are representations of exemplary control schemes of a media device via a wearable device such as headset having an IR sensor in accordance with embodiments of the present techniques.

FIG. 6 is a block diagram of an example tangible, non-transitory computer-readable medium to implement embodiments of the present techniques.

FIG. 7 is a perspective view of a media device and a wearable device such as a headset in accordance with embodiments of the present techniques.

FIG. 8 is a media device configured to couple with a headset having an IR sensor in accordance with embodiments of the present techniques.

FIG. 9 is a method of operating a media device and a headset having an IR sensor in accordance with embodiments of the present techniques.

### DETAILED DESCRIPTION

Embodiments of the present techniques relate to wearable devices (such as headsets)associated with an electronic or computing device, and the wearable device having inner ear-skin temperature sensing to facilitate control of the electronic or computing device (e.g., a media device or player such as radio or media playback device). In particular, the techniques may provide for a wearable device, such as a headset, headphone, computer glasses, smartphone, etc., having (e.g., embedded with) an infrared (IR) sensor to measure the ear-skin temperature including the inner ear-skin temperature. This measured temperature value may be used as a basis for control of the electronic device (e.g., media device or player)coupled to the wearable device (e.g., a headset). Such control may include on/off, play and pause actions, and volume controls, for example.

Advantageously, the control may be more reliable with a lower misoperation ratio than via capacitive sensing, for example, because the inner ear-skin temperature is generally a substantially constant temperature and typically higher (and more steady)than the human-body surface temperature generally. Thus, the headset control is less likely to confuse contact of the headset with human skin generally versus contact with an inward portion of the ear. Therefore, the headset may more reliably determine when the headset is in place on or in the ears, and thus when typically desired for the associated media player to be in a play or playback operation. Again, the headsets of the present techniques having an IR sensor may be more reliable and with lower misoperation than conventional headsets employing capacitive motion sensors, for example. Consequently, the user experience may be improved due to better or increased automatic control, for instance. It should be noted that the inner ear-skin temperature may be measured at a relatively constant 36° C. or 37° C., or therebetween, depending on calibration and sensor distance, for example.

Embodiments also provide for improve control generally and in particular techniques via the IR sensors and associated control logic in accommodating additional remote control functions of the media device. In fact, the user may actively participate in the remote control via handling of the wearable device (e.g., headset including the earphones), for instance. In examples, the user may move the earphones in and out of the ear to activate certain functions of the media device, as discussed below.

Lastly, while the discussion may focus on utilizing IR temperature sensors in the control via a “headset” of a media player device, the present techniques may be applicable to IR temperature sensing and associated control of other extended and host devices including computing devices, computer glasses, smartphones, and other wearable devices, and may be directed to actions other than audio playback. Indeed, there are a variety of main devices and their control that may benefit from the transfer of IR sensor data to the main device, and in which may utilize the unique control techniques described herein.

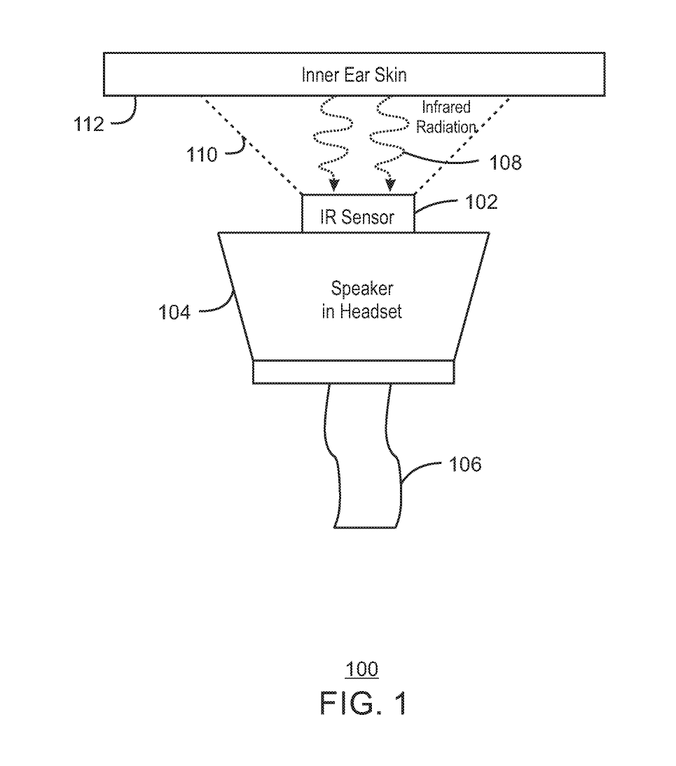

FIG. 1 is a portion of wearable device which in this embodiment is an exemplary headset 100 having an IR sensor 102 to measure temperature. The IR sensor 102 is mounted on or embedded in a headset speaker 104 coupled to a wire 106 of the headset 100. The same or similar configuration of an IR temperature sensor may be implemented on a second speaker (not shown) of the headset 100.

The temperature value measured by the IR sensor 102 may be utilized for remote control (e.g., smart remote control) of a media player coupled to the headset 100. In certain embodiments for remote control of the media device or player, a circuit, processor, or controller in the media device may receive and process raw data or a raw signal from the IR sensor indicating the measured temperature. In alternate embodiments, a processor or controller may reside in the headset and provide for control processing of the raw data or signal from the IR sensor.

As for the IR sensor 102, it may sense and detect radiation 108 emitted by an object in the field of view 110 of the sensor 102. In the illustrated embodiment, the “object” or surface is inner-ear skin 112, as the speaker 102 is depicted adjacent a human ear. The IR sensor 102 and a processor may infer temperature via infrared or thermal radiation (blackbody radiation) emitted by an object or surface being measured.

For an IR sensor generally, the sensed amount of infrared energy or radiation emitted by the object, compared with the object's known emissivity, may typically determine the object's temperature. Generally, the infrared temperature sensor 102 may collect radiation from a target (inner ear skin in the illustrated example) in a field of view 110 defined by the sensor's optics and location, for instance. In embodiments, the infrared energy may be isolated and measured, and converted into an electrical signal and then into a temperature value based on algorithms and the target's emissivity (a term referring to the emitting qualities of the target's surface).

Again, in the instant case, the measured temperature value may be utilized for remote control (e.g., smart remote control) of a media device or player coupled to the headset 100 and that provides an audio signal to the headset 100. In embodiments, the earphone or earbud of a headset has an IR sensor that measures infrared radiation emitted from an object within the sensor field of view. This IR sensor data indicates temperature of the object and is sent to the main or host device such as the media device.

In certain examples, the media device (and associated hardware, firmware, and software) may receive and process the raw indication or signal from the IR sensor 102 to facilitate control of the media device via the headset 100 and IR sensor 102.In particular examples, no significant processing occurs on the headset 100 but instead is performed at the media device. Nevertheless, the infrared temperature sensor 102 is configured to facilitate detection of when the earphone, earbud, or speaker of the headphone or headset 102 is inserted in or on the ear, or is not inserted in or not on the ear.

As noted above, the IR sensor 102 which is configured to measure temperature of the inward or inner ear skin may uniquely provide for improved and more reliable control due, in part, to the stability of the inner ear-skin temperature. Indeed, the inner ear temperature is typically at a relatively constant and steady temperature value generally in the range of 36° C. to 37° C. Moreover, even in cases where the ambient temperature is at the specified inner ear temperature value, the headset 100, IR sensor 102, and media device processor may generally differentiate between the inner ear temperature versus an ambient temperature of the same value. In particular, such differentiation may be feasible due to the stability of the inner ear-skin temperature versus the typical instability of an ambient temperature caused by light interferences and other interferences with the IR sensor 102 (i.e., when the sensor is removed from the ear and exposed to ambient or environment).

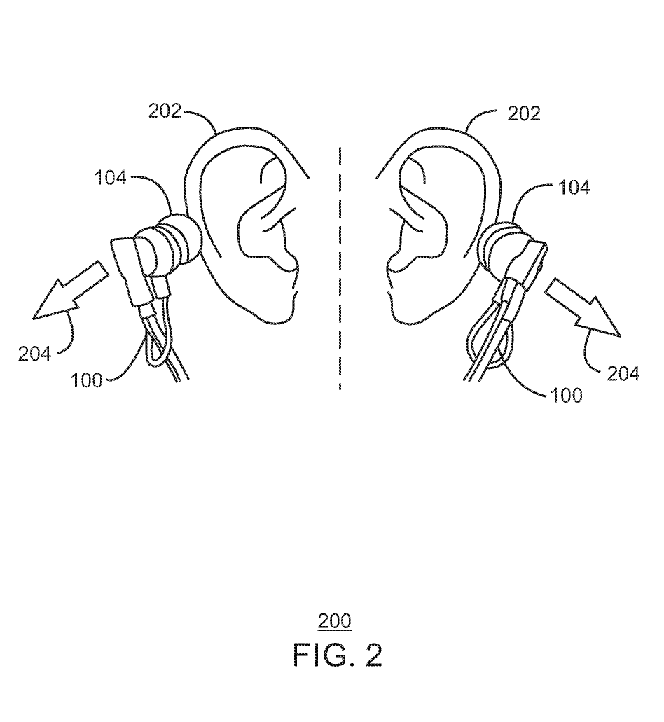

In all, the infrared temperature sensor 102 is configured to facilitate detection of the speaker 104 of the headset 102 is inserted into or adjacent the ear, and the speaker 104 not inserted or adjacent the ear. As indicated below with respect to FIGS. 2-5, this unique increased reliability and precision via the IR sensor 102 (and associated control) benefits remote control of play/pause and additional functions of the media device.

FIGS. 2-5 are representations of exemplary headset control schemes of a media device that may be implemented by user actions via the headset 100 and its IR sensor 102, and the media device processor or controller. The control schemes may rely on detection via the IR temperature sensor 102 of placement of the speaker 104 of the headset 100 relative to the human ear. FIG. 2 is such an example of a control scheme.

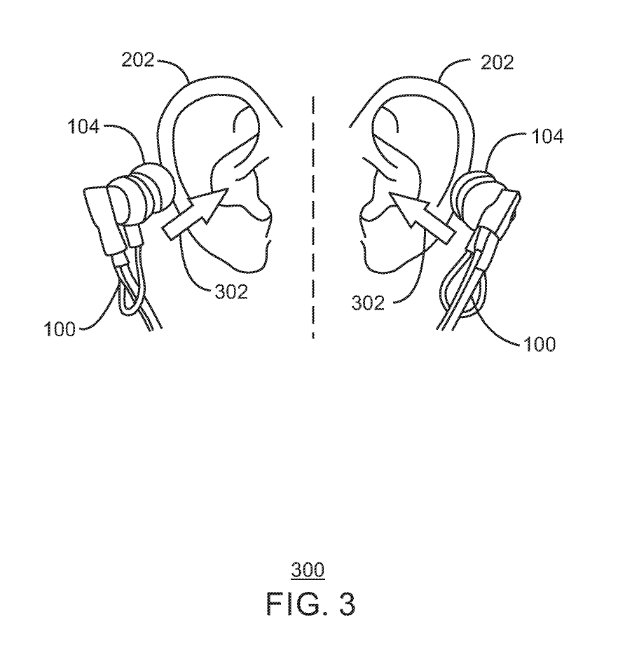

FIG. 3 is an exemplary control scheme representation 200 showing that removal of the speakers 104 from the left and right ears 202, as indicated by arrows 204, may stop play or playback of the media device or player. FIG. 3 is an exemplary control scheme representation 300 showing insertion or placement of the speakers 104 in or on the left and right ears 204, as indicated by arrows 302, may initiate or start play or playback via the media device or player.

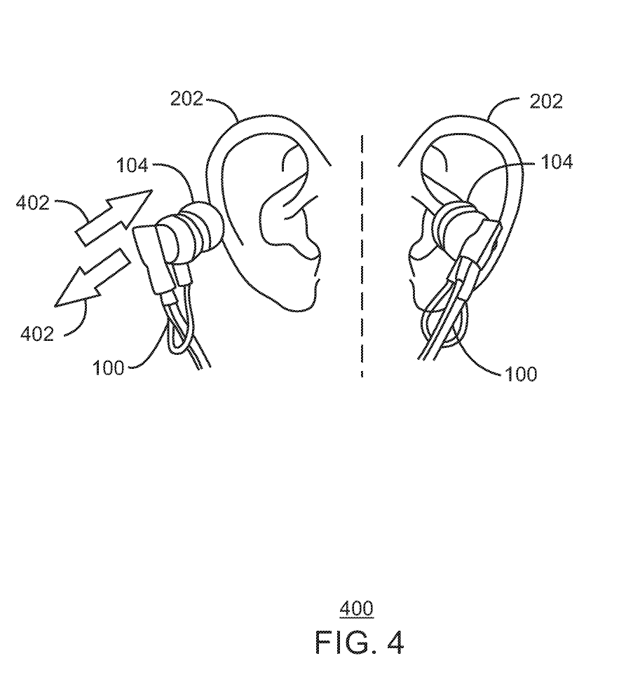

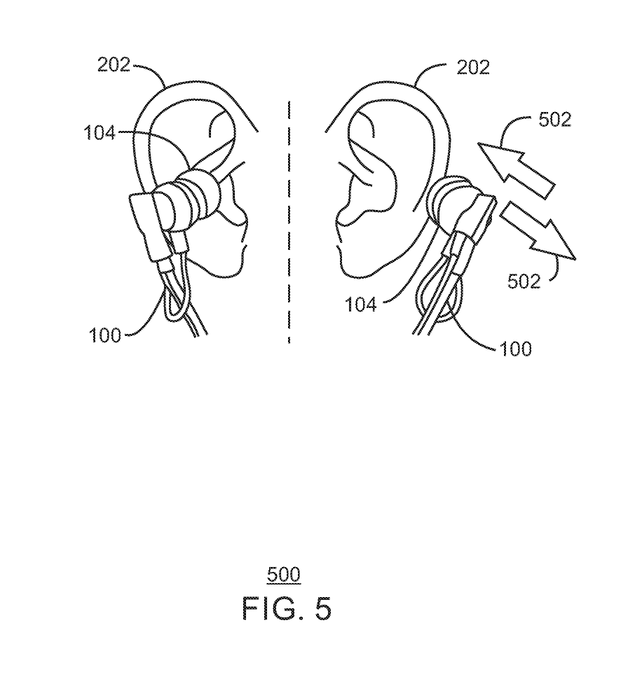

FIGS. 4 and 5 are exemplary control schemes for adjusting (increasing or decreasing) volume of the media device playback based on maintaining one speaker 104 in place in one ear 202, and moving the other speaker 104 out and in of the other ear 202. In particular, FIG. 4 is a control scheme representation 400 showing maintaining one speaker 104 in the left ear 202, and moving the other speaker 104 out and in of the right ear 202, as indicated by arrows 402 Such increases the volume of the media device. FIG. 5 is a control scheme representation 500 showing maintaining one speaker 104 in the right ear 202, and moving the other speaker 104 out and in of the left ear 202, as indicated by arrows 502. Such decreases the volume of the media device. Of course other control schemes of volume adjustments may be implemented. Moreover, control via the headset 100 (having IR sensors 102) of additional functionalities of the media device, other than those of FIGS. 2-5, may be implemented.

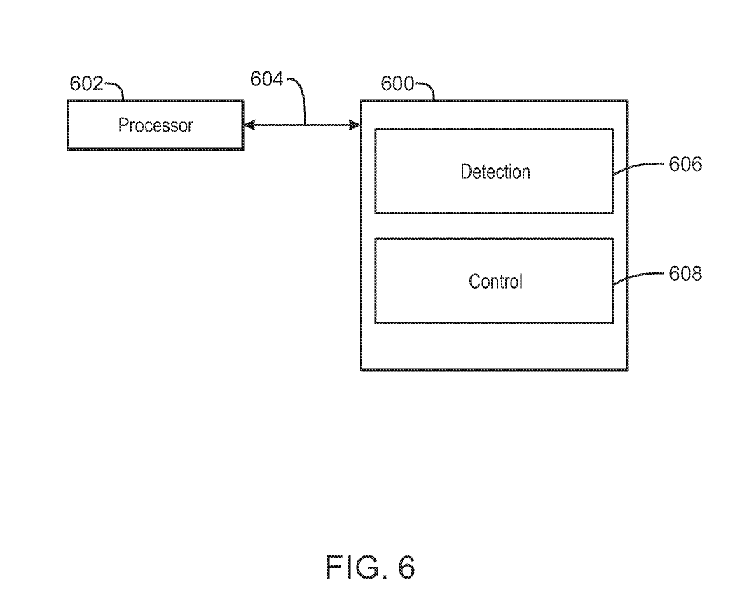

FIG. 6 is a block diagram depicting an example of a tangible, non-transitory computer-readable medium that can facilitate detection a headset speaker as on or off a human ear via an IR sensor and to provide for control including automatic control of a media device coupled to the headset and based on the detection of the speaker. The computer-readable medium 600 may be accessed by a processor 602 over a computer interconnect 604. Furthermore, the tangible, non-transitory, computer-readable medium 600 may include code to direct the processor 602 to perform the operations of the techniques described herein.

The various software components discussed herein may be stored on the tangible, non-transitory, computer-readable medium 600, as indicated in FIG. 6. For example, a detection module 606 may direct the processor 602 to detect a position of a speaker of a headset relative to a human ear via an IR sensor disposed on or in the speaker. A control module 608 may direct the processor 602 to facilitate control including automatic control of a media device coupled to the headset in response to the detection of the speaker position relative to the human ear, i.e., as on or off the human ear. It is to be understood that any number of additional software components not shown in FIG. 6 may be included within the tangible, non-transitory, computer-readable medium 600, depending on the specific application.

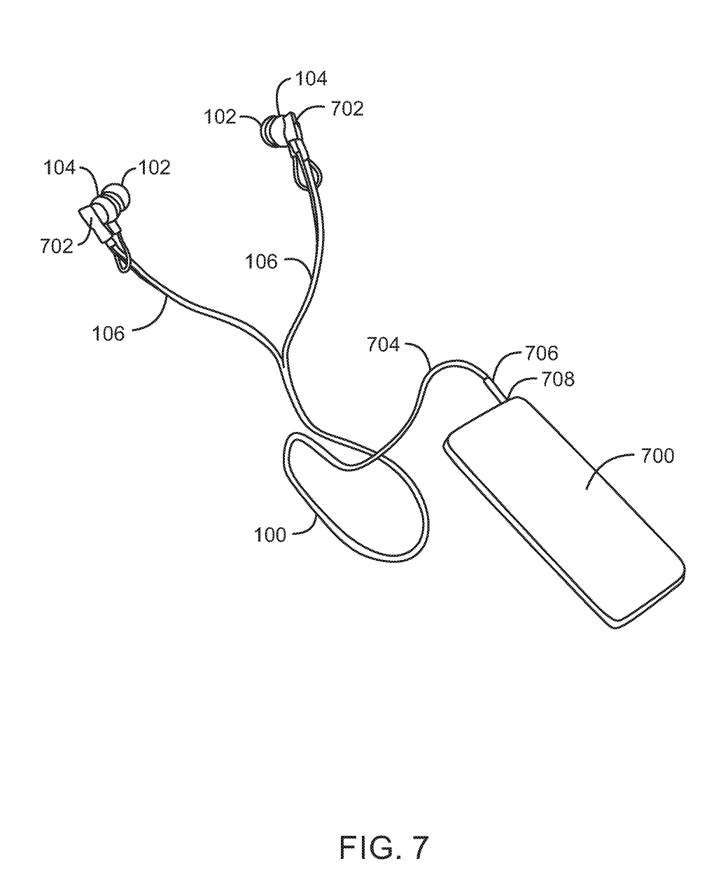

FIG. 7 is an exemplary headset 100 and media device 700.The headset 100 is depicted with earbuds 702. However, the earbuds 702 may instead be configured as over-the-ear head components or speakers, for example, or other geometries and configurations. Further, the headset 100 may optionally include a user control interface, such as physical buttons (not shown) for control of streaming or playback (play, pause, stop, volume adjustment, etc.) of audio files from the media device 700. As for the media device 700, it may be a variety of electronic or computing devices which can act as a media player, such as a portable dedicated media player, smartphone, tablet device, laptop, desktop computer, all-in-one (AIO) computing system, television, stereo system, and so forth. The media device 700 may include a physical and/or virtual control interface (not shown) for user adjustment of play of audio files or other files and data.

In the illustrated embodiment, the headset 100 has earbuds 702 each with a respective speaker 104 having an embedded IR temperature sensor 102. Respective wires 106 route audio transmission from the media device 700 to the speakers 104 (i.e., for play of audio files), as well as route IR temperature signals from the IR temperature sensors 102 to the media device 700. In certain embodiments, the signal indicating temperature is a raw (e.g., relatively unprocessed) signal from the sensor 102 to the media device 700. In alternate embodiments, the signal may be a processed signal (for control of the media device 700) via optional circuitry and executable logic in the headset 100.

In the illustrated example, the wires 106 are routed together, as indicated by reference numeral 704, to a jack 706 for coupling to the media device 700. In alternate embodiments in lieu of (or in addition to) the wires 106 and jack 706, the earbuds 702 and media device 700 may be configured for wireless communication. Again, the communications, whether wireless or via wires 106, can include transmission of audio from the media device 700 to the headset 100, and transmission of a signal indicating temperature from the headset 100 to the media device 700. Other communications are applicable.

The media device 700 may generally include a coupling element 708 to in effect receive the wires 106. In this example, the wires 106 are ultimately routed together, as indicated by reference numeral 704, to the jack 706 of the headset 100. Thus, in examples, the coupling element 708 mates with the jack 706 to couple the headset 100 with the media device 700.

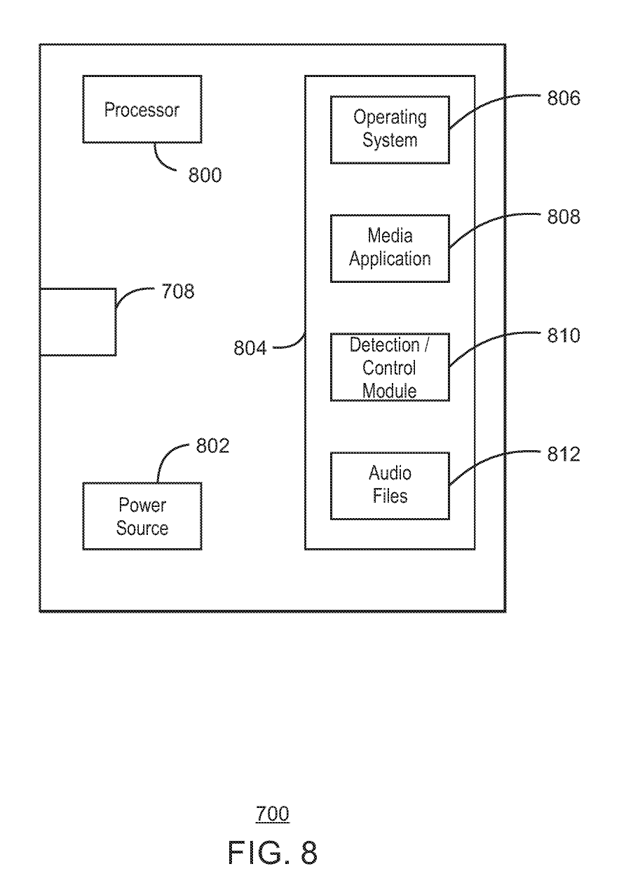

FIG. 8 is an exemplary media device 700 which may couple with a wearable device or headset 100 (e.g., FIGS. 1-5 and 7) having an IR sensor. In certain embodiments, the headset 100 may have a speaker 104 embedded with the IR sensor 102. In operation, the media device 700 may play audio files and send an audio signal to the headset 100 so that a user can listen to the audio file via one or more speakers 104 of the headset 100. Further, the media device 700 may receive a raw or relatively unprocessed signal from the headset 100, the signal indicative of temperature measured by the IR sensor 102. The media device 700 may receive signals indicative of temperatures measured by more than one temperature sensor 102, such with a respective IR sensor 102 embedded in each of two speakers 104 of the headset 100. The raw signals received from the IR sensor(s) 102 and indicative of temperature may be processed by the media device 700 to be used in control of the media device 700.

As for components, the media device 700 may have a controller or processor 800. The media device 700 may include a coupling element 708 that facilitates mating of a wearable device or headset 100 (FIG. 7) to the media device 700. For example, the coupling element 708 may be a female connection to receive a wire jack 706 (FIG. 7) of a headset 100.In alternate embodiments, the coupling element 708 or other part of the media device 700 may involve a wireless communication component for wireless coupling of the wearable device or headset 100 to the media device 700. Additionally, the media device 700 may include a power source 802 such as battery including a rechargeable battery. Of course, the media device 700 may be configured to receive power from an outside power source.

In all, the media device 700 may be an electronic or computing device that provides for media play. The device 700 may be a stationary or home device, or a mobile or hand held device, and so on. Examples of the media device 700 may include a media player, smartphone, tablet device, laptop, desktop computer, all-in-one (AIO) computing system, television, stereo system, and so forth. As mentioned with respect to FIG. 7, the media device 700 may include a physical and/or virtual control interface or buttons (not shown) for user adjustment of play of audio files or other files and data.

The media device 700 may include memory 804 storing logic or code executable by the processor 800 or other processor. Such code may generally include an operating system 806 for control of the media device 700. Further, associated with the operating system 806, the memory 804 may store executable logic of a media application 808 including to accommodate the streaming or playback of audio files and other files.

Additionally, in accordance with embodiments of the present techniques, the media device 700 may be configured with the memory 804 storing executable logic of a detection and control module 810. In certain embodiments, the detection and control module 810 may interface with the operating system 806 and media application 808. The detection and control module 810 may implement techniques described herein. The techniques may involve processing of the signal received from the IR sensor 102 indicating temperature, such as in determining measured temperature value and its stability, as well as the associated detection of a position of the headset 100.

For example, for a media device 700 coupled to a wearable device or headset 100 having an IR temperature sensor 102, the detection/control module 810 may facilitate detection, via the processor 800 and the IR temperature sensor 102, the position of the headset 100 (or headset speaker 104) relative to an ear of a human, e.g., as on the ear and as not on the ear. In a further example, when the headset 100 is detected as not on the ear of the human, the detection/control module 810 logic when executed by the processor may direct the media device 700 to implement an automatic stop play function of the media device 700.

Also, in examples, the module 810 when executed may direct implementation of an automatic play function of the media device 700 in response to detection of the headset 100 (or headset speaker 104) as on the ear of the human, for instance. In additional embodiments, the module 810 when executed may facilitate volume adjustment control, as discussed above with respect to FIGS. 4 and 5, for example. The detection/control module 810 incorporate additional detection and control techniques with respect to the headset 100 and its IR sensor 102, and the media device 700.

Moreover, in alternate embodiments, the processing of the IR sensor 102 signal, and aspects of the logic of the detection/control module 810 and execution of such aspects may be off loaded from the media device 700 to the headset 100. Indeed, the headset 100 may include the circuitry or processor and memory storing executable logic to more accommodate and/or implement determining of the measured IR sensor temperature and its stability, and the aforementioned detection and control. Lastly, a user may store audio files 812 (for playback) on a portion of the memory 804.

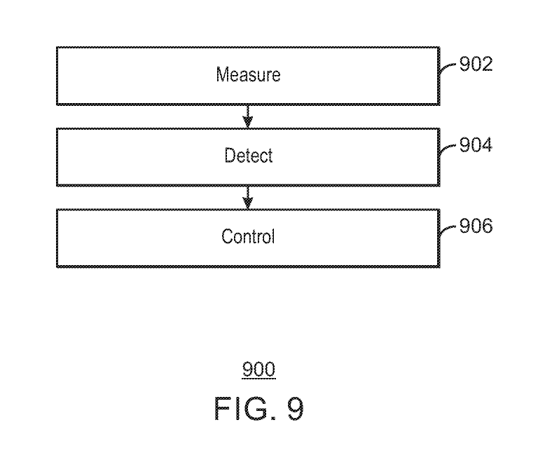

FIG. 9 is a method 900 of operating a media device or media player and a headset having an IR sensor. The method 900 includes measuring (block 902) via the IR sensor a temperature adjacent the IR sensor, and determining or detecting (block 904) via a processor a position of the headset (or a headset speaker having the IR sensor) relative to an ear of a human user based on the measured temperature. In particular, the headset or headset speaker position may be determined or detected as on the human ear and as off the human ear. In examples, the measuring, via the IR sensor, of skin temperature of the ear of the user may facilitate detection of the speaker as on the ear of a user.

The method 900 may control (block 906) the media device coupled to the headset based at least in part on the measured temperature and the detection of the headset or headset speaker position relative to the ear of the user. The detection of the headset or speaker as not on the ear of the user may lead to an automatic stop function of the media device. The detection of the headset or speaker as on the ear of the user may lead to a play function of the media device. In examples with the headset having a second speaker (for the other ear), and wherein the detection of the first speaker as not on an ear of the user while the second speaker is on an ear of the user may lead to an automatic adjustment of volume of the media device. In general, the detection and control technique discussed above with respect to FIGS. 1-8 may be implemented in the method 900. Also, other detection and control schemes may be implemented in the method 900 via the IR sensor, processor, and control logic, and so forth.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,”“some embodiments,”“various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

### EXAMPLE 1

An example relates to a wearable device (e.g., headset)comprising an infrared (IR) temperature sensor to facilitate control of a media device coupled to the wearable device. The wearable device or headset may include a speaker having the IR temperature sensor. The speaker may be configured to be adjacent a human ear, and with the IR temperature sensor to measure skin temperature of the human ear. Further, the headset via the IR temperature sensor may facilitate detection of a position of the speaker relative to a human ear, and in which such detection of the may lead to an automatic action of the media device. The detection of the position of the headset relative to a human ear may support automatic control of a function of the media device.

The headset via the IR temperature sensor may facilitate detection of the speaker as not in a human ear. The detection of the speaker as not in a human ear may be based on a temperature indicated by the IR temperature sensor as not a substantially constant temperature. Further, the headset may support an automatic stop action of the media device in response to detection of the speaker as not in a human ear. Additionally, the headset via the IR temperature sensor may facilitate detection of the speaker as in a human ear. Inn operation of the headset, the headset may provide a signal to the media device indicating temperature. The headset via the IR temperature sensor and the signal may facilitate adjustment of volume of the media device. In embodiments, the headset may include earbuds, and/or the media device may be a media player.

### EXAMPLE 2

Another example is a method of operation of a headset having a speaker and an infrared (IR) sensor, the method including enabling, via the IR sensor, detection of the speaker as on an ear of a user and detection of the speaker as not on the ear of a the user. The method may include facilitating control of a media device coupled to the headset based on detection of the speaker relative to the ear of the user.

The method may include measuring, via the IR sensor, skin temperature of the ear of the user to facilitate detection of the speaker as on the ear of a user, and wherein the detection of the speaker as not on the ear of the user may lead to an automatic stop function of a media device coupled to the headset. Detection of the speaker as on the ear of the user may lead to a play function of a media device coupled to the headset. The headset may include a second speaker, and wherein the detection of the speaker as not on an ear of the user while the second speaker is on an ear of the user may lead to an automatic adjustment of volume of a media device coupled to the headset.

### EXAMPLE 3

Other examples may involve a non-transitory, computer-readable medium having instructions that, in response to being executed on a processor, cause the processor to automatically control a media device coupled to a wearable device (e.g., headset) having a speaker with an IR temperature sensor, the automatic control based on measured temperature indicated by the IR temperature sensor. The instructions may cause the processor to: (1) detect, via the IR temperature sensor, positions of the speaker relative to a human ear as on a human ear and as not a human ear; and (2) automatically control the media player coupled to the headset based on detecting the positions of the speaker relative to the human ear. The automatic control may include implementing an automatic stop function of the media device in response to detection of the speaker as not on the human ear, and/or implementing an automatic play function of the media device in response to detection of the speaker as on the human ear. The headset may include a second speaker, and wherein the automatic control includes implementing an automatic volume adjustment of the media device in response to the detection of the speaker as not on the human ear while the second speaker is on a second human ear.

### EXAMPLE 4

Yet other examples may relate to media device configured to couple to a headset having an IR temperature sensor, the media device including a processor and a memory storing code executable by the processor. The code when executed may direct the media device to: detect, via the IR temperature sensor, position of the headset relative to an ear of a human as on the ear of the human and as not on the ear of the human; and control the media device at least in part based on the detected position of the headset relative to the ear of the human. The control may include implementing an automatic stop function of the media device in response to detection of the headset as not on the ear of the human. The headset may include a first speaker having the IR sensor (a first IR sensor), and a second speaker having a second IR sensor, and wherein the control includes implementing an automatic volume adjustment of the media device in response to detection via the IR sensor of the first speaker as not on the ear of the human in conjunction with detection via the second IR sensor of the second speaker as not on a second ear of the human.

1-25. (canceled)

26. A wearable device comprising an infrared (IR) temperature sensor to facilitate control of a media device coupled to the wearable device.

27. The wearable device of claim 26, wherein the wearable device is to be worn adjacent a human ear, and wherein the control of the media device is based at least in part on measured temperature indicated by the IR temperature sensor.

28. The wearable device of claim 26, wherein the wearable device comprises a headset, and wherein the headset comprises a speaker having the IR sensor.

29. The wearable device of claim 28, wherein the speaker is to be placed adjacent a human ear, and the IR temperature sensor to measure skin temperature of the human ear.

30. The wearable device of claim 28, wherein the headset via the IR temperature sensor facilitates detection of a position of the speaker relative to a human ear.

31. The wearable device of claim 30, wherein the detection of the position of the speaker relative to a human ear leads to an automatic action of the media device.

32. The wearable device of claim 30, wherein the detection of the position of the speaker relative to a human ear supports automatic control of a function of the media device.

33. The wearable device of claim 28, wherein the headset via the IR temperature sensor facilitates detection of the speaker as not in a human ear.

34. The wearable device of claim 33, wherein the detection of the speaker as not in a human ear is based at least in part on a temperature indicated by the IR temperature sensor as not a substantially constant temperature value.

35. The wearable device of claim 33, wherein the headset supports an automatic stop action of the media device in response to detection of the speaker as not in a human ear.

36. The wearable device of claim 28, wherein the headset via the IR temperature sensor facilitates detection of the speaker as in a human ear.

37. The wearable device of claim 28, wherein in operation of the headset, the headset provides a signal to the media device indicating temperature.

38. The wearable device of claim 37, wherein the headset via the IR temperature sensor and the signal facilitates adjustment of volume of the media device.

39. The wearable device of claim 26, wherein the wearable device comprises a headset having earbuds.

40. A method of operation of a headset having a speaker and an infrared (IR) sensor, the method comprising:
detecting, via the IR sensor, the speaker relative to the ear of the user, as on the ear of a user and as not on the ear of the user; and
facilitating control of a media device coupled to the headset based on the detection of the speaker relative to the ear of the user.

41. The method of claim 40, comprising measuring, via the IR sensor, skin temperature of the ear of the user to facilitate detection of the speaker as on the ear of a user.

42. The method of claim 40, wherein the detection of the speaker as not on the ear of the user leads to an automatic stop function of the media device.

43. The method of claim 40, wherein the detection of the speaker as on the ear of the user leads to a play function of the media device.

44. The method of claim 40, wherein the headset comprises a second speaker, and wherein the detection of the speaker as not on an ear of the user while the second speaker is on an ear of the user leads to an automatic adjustment of volume of the media device.

45. A non-transitory, computer-readable medium comprising instructions that, in response to being executed on a processor, cause the processor to:
manage a media device coupled to a wearable device having a speaker with an IR temperature sensor, the managing based in part on measured temperature indicated by the IR temperature sensor, and the managing comprising to:
detect, via the IR temperature sensor, positions of the speaker relative to a human ear as on a human ear and as not on a human ear; and
automatically control the media device coupled to the headset based on detected positions of the speaker relative to the human ear.

46. The non-transitory, computer-readable medium of claim 45, wherein the automatic control comprises:
implementing an automatic stop function of the media device in response to detection of the speaker as not on the human ear; and
implementing an automatic play function of the media device in response to detection of the speaker as on the human ear.

47. The non-transitory, computer-readable medium of claim 45, wherein the headset comprises a second speaker, and wherein the automatic control comprises implementing an automatic volume adjustment of the media device in response to the detection of the speaker as not on the human ear while the second speaker is on a second human ear.

48. A media device configured to couple to a headset comprising an IR temperature sensor, the media device comprising:
a processor;
a memory storing code executable by the processor to:
detect, via the IR temperature sensor, position of the headset relative to an ear of a human as on the ear of the human and as not on the ear of the human; and
control the media device at least in part based on the detected position of the headset relative to the ear of the human.

49. The media device of claim 48, wherein the control comprises implementing an automatic stop function of the media device in response to detection of the headset as not on the ear of the human.

50. The media device of claim 48, wherein the headset comprises a first speaker comprising the IR sensor, and a second speaker comprising a second IR sensor, and wherein the control comprises implementing an automatic volume adjustment of the media device in response to detection via the IR sensor of the first speaker as not on the ear of the human in conjunction with detection via the second IR sensor of the second speaker as not on a second ear of the human.
